(19) United States
(12) Patent Application Publication
(10) Pub. No.: US 2022/0127547 A1
(43) Pub. Date: Apr. 28, 2022

(54) ALPHA-OLEFIN SULFONATE-CONTAINING DISHWASHING AGENTS

(71) Applicant: Henkel AG & Co. KGaA, Duesseldorf (DE)

(72) Inventors: Marianne SCHMELING, Korschenbroich (DE); Detlef BUISKER, Essen (DE); Ute JAESCHKE, Leverkusen (DE); Lisa-Marie SCHUETZ, Hilden (DE)

(21) Appl. No.: 17/430,338

(22) PCT Filed: Feb. 19, 2020
(86) PCT No.: PCT/EP2020/054385

§ 371 Date: Aug. 12, 2021

(30) Foreign Application Priority Data
Feb. 20, 2019 (DE) 10 2019 104 269.0

(51) Int. Cl. C11D 1/83; C11D 11/00; C11D 1/14; C11D 1/22; C11D 1/75

(52) U.S. Cl. CPC C11D 1/83; C11D 11/0023; C11D 1/75; C11D 1/22; C11D 1/143

(57) ABSTRACT

Dishwashing agents may include a surfactant system having at least one alpha-olefin sulfonate and an additional surfactant different from the alpha-olefin sulfonate. The additional surfactant may be at least one anionic and/or non-ionic surfactant. The dishwashing agent may be used for manually washing dishes.

### CROSS-REFERENCE TO RELATED APPLICATIONS

The present application is a national stage entry according to 35 U.S.C. § 371 of PCT application No.: PCT/EP2020/054385 filed on Feb. 19, 2020; which claims priority to German Patent Application Serial No.: 10 2019 104 269.0 filed on Feb. 20, 2019; all of which are incorporated herein by reference in their entirety and for all purposes.

### TECHNICAL FIELD

The present invention relates to dishwashing agents containing a surfactant system, the surfactant system comprising at least one alpha-olefin sulfonate and at least one additional surfactant different from the alpha-olefin sulfonate where the additional surfactant is an anionic and/or non-ionic surfactant. The present invention also relates to the use of the dishwashing agent according to the invention for manually cleaning dishes.

### BACKGROUND

Dishwashing agents, in particular liquid dishwashing agents for manually cleaning dishes, are known. With a view to sustainability, compatibility with the skin and a simpler manufacturing process, it would be desirable to manufacture such dishwashing agents with the lowest possible proportion of organic solvents.

### SUMMARY

This object was surprisingly achieved by the inventors by providing a dishwashing agent that contains a surfactant system comprising at least one alpha-olefin sulfonate and at least one other anionic or non-ionic surfactant. It was surprisingly found that the addition of alpha-olefin sulfonate resulted in an improvement in the solubility of the surfactant system and consequently organic solvents could be saved. By avoiding organic solvents, the manufacturing process for the dishwashing agents can also be shortened.

In a first aspect, a dishwashing agent may include a surfactant system, the surfactant system comprising or consisting of:

(A) at least one alpha-olefin sulfonate;
(B) optionally at least one other anionic surfactant different from (A); and
(C) optionally at least one non-ionic surfactant,
with the proviso that at least one other surfactant (B) or (C) is present.

In another aspect, the dishwashing agent may be used for manually cleaning dishes.

### DETAILED DESCRIPTION

“At least one,” as used herein, refers to 1 or more, for example 2, 3, 4, 5, 6, 7, 8, 9 or more. In connection with constituents of the compounds described herein, this statement refers not to the absolute amount of molecules, but rather to the type of constituent. “At least one surfactant” therefore means, for example, that only one type of surfactant compound or a plurality of different types of surfactant compounds can be contained without specifying the amount of the individual compounds.

All amounts stated in connection with the dishwashing agents described herein refer to wt. %, in each case based on the total weight of the dishwashing agent, unless indicated otherwise. Moreover, stated amounts of this kind that refer to at least one constituent always refer to the total amount of this type of constituent contained in the dishwashing agent, unless explicitly indicated otherwise. That means that amounts of this kind, for example in the context of “at least one surfactant,” refer to the total amount of surfactants contained in the dishwashing agent unless explicitly indicated otherwise.

Numbers stated herein with no decimal places refer to the full specified value with one decimal place. For example, “99%” stands for “99.0%.”

The terms “about” or “approximately” in connection with a numerical value refer to a variance of ±10% in relation to the specified numerical value, preferably ±5%, particularly preferably ±1%.

The expression “substantially free of” means that the particular compound can in principle be contained, but is then present in an amount that does not impair the function of the other components. The property “substantially free of” a particular compound is therefore preferably a total amount of less than 0.1 wt. %, more preferably less than 0.001 wt. %, in particular is free of said compound, based on the total weight of dishwashing agent.

Numerical ranges that are specified in the format “in/from x to y” include the stated values. If several preferred numerical ranges are indicated in this format, it is readily understood that all ranges that result from the combination of the various endpoints are also included.

Information on the molecular weight relates to the weight-average molecular weight in g/mol, unless the number-average molecular weight is explicitly mentioned. Molecular weights are preferably determined by means of GPC using polystyrene standards.

Within the scope, unless indicated otherwise, fatty acids and/or fatty alcohols and/or the derivatives thereof are representatives of branched or unbranched carboxylic acids and/or alcohols and/or the derivatives thereof preferably having 6 to 22 carbon atoms. In particular, the oxo-alcohols or derivatives thereof which can be obtained, for example, by Roelen's oxo synthesis can be correspondingly used.

If constituents of the present agents are salts, they are preferably alkali metal or alkaline earth metal salts of the respective compounds, more preferably the alkali metal salts, in particular the sodium or potassium salts, most preferably sodium salts, thereof. Whenever alkaline earth metals are mentioned in the following as counterions for monovalent anions, this means that the alkaline earth metal is naturally only present in half the amount of substance—sufficient to balance the charge—as the anion.

Substituted groups are preferably those groups in which the substituent is selected from —F, —Cl, —Br, —OH, —OC₁₋₄ alkyl, ═O, —NH₂, or —N(C₁₋₄ alkyl)₂, the substituent preferably replacing one or more H atoms.

These and other aspects, features and advantages will become apparent to a person skilled in the art through the study of the following detailed description and claims. Any feature or any embodiment from one aspect can be used in any other aspect. For example, described features or embodiments of the dishwashing agents can also be applied to the claimed uses, and vice versa. Furthermore, it will readily be understood that the examples contained herein are intended to describe and illustrate, but not to limit, the invention and that, in particular, the invention is not limited to these examples.

The dishwashing agent contains a surfactant system which comprises or consists of at least one alpha-olefin sulfonate and at least one other different anionic surfactant or at least one non-ionic surfactant.

In a particularly preferred embodiment, the dishwashing agent contains a surfactant system which comprises or consists of at least one alpha-olefin sulfonate and at least one non-ionic surfactant, the non-ionic surfactant preferably being an amine oxide, particularly preferably a C₁₂-18 amine oxide, in particular a C₁₂-18 alkyl dimethyl amine oxide. In other preferred embodiments, the at least one non-ionic surfactant is a Cu-14 amine oxide, for example a Cu-14 alkyl dimethyl amine oxide.

In various embodiments, the preferred surfactant system, which comprises at least one alpha-olefin sulfonate and at least one non-ionic surfactant, can further contain another anionic surfactant different from the at least one alpha-olefin sulfonate.

The dishwashing agent is substantially free of cationic surfactants.

The at least one alpha-olefin sulfonate can be selected from known alpha-olefin sulfonates. It is preferably selected from C₁₀₋₂₀ alpha-olefin sulfonates, more preferably from linear C₁₀₋₂₀ alpha-olefin sulfonates. In particular, it is selected from C₁₂₋₁₄ alpha-olefin sulfonates; most preferably it is a linear C₁₂₋₁₄ alpha-olefin sulfonate.

The at least one alpha-olefin sulfonate is preferably contained in 2.5 to 50 wt. %, more preferably 3 to 30 wt. %, particularly preferably 5 to 25 wt. %, based on the total weight of the dishwashing agent.

A suitable alpha-olefin sulfonate is commercially available, for example, under the trade name Bio-Terge® AS-40 from Stepan.

If present, the at least one other anionic surfactant which is different from alpha-olefin sulfonates is preferably contained in 0.1 to 45 wt. %, preferably 0.5 to 40 wt. %, more preferably in 1 to 25 wt. %, based on the total weight of the dishwashing agent.

All anionic surfactants known for dishwashing agents are suitable as other anionic surfactants.

In one embodiment, the at least one other anionic surfactant is selected from alkylbenzene sulfonates, alkyl sulfates and mixtures thereof.

In a preferred embodiment, the other anionic surfactant is selected from linear or branched alkylbenzene sulfonates of formula A-1

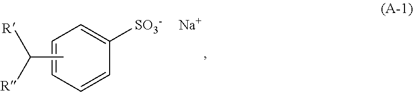

in which R′ and R″ represent, independently of one another, H or a linear C₂₋₁₈ alkyl group, preferably together represent a C₉₋₁₈ alkyl group, where at least one group is not H. R′—CH—R″ is preferably a C₉₋₁₃ alkyl group. In addition to the sodium salts shown in formula A-1, salts with other inorganic or organic cations can also be used.

Short-chain alkylbenzene sulfonates of formula A-1 in which R′ and R″ together represent a C₂-C₈ alkyl group, such as cumene sulfonate, can also be used as a hydrotropic substance. Hydrotropic substances of this kind, in particular cumene sulfonate, are preferred constituents of the agents and can be used in amounts of up to 5 wt. %, for example up to 2 wt. %.

Other suitable anionic surfactants are the alkyl sulfates of the formula

R²—O—SO₃⁻X⁺ (II).

In this formula (II), R² represents a linear or branched, substituted or unsubstituted alkyl group, preferably a linear, unsubstituted alkyl group, particularly preferably a fatty alcohol group. Preferred groups R² are selected from decyl, undecyl, dodecyl, tridecyl, tetradecyl, pentadecyl, hexadecyl, heptadecyl, octadecyl, nonadecyl and eicosyl groups, and mixtures thereof, with the representatives having an even number of C atoms being preferred. Particularly preferred groups R² are derived from C₁₂₋₁₈ fatty alcohols, for example from coconut fatty alcohol, tallow fatty alcohol, lauryl, myristyl, cetyl or stearyl alcohol or from C₁₀₋₂₀ oxo alcohols.

X represents a monovalent cation or the n-th part of an n-valent cation, the alkali metal ions being preferred, and of those Na⁺ or K⁺, with Na⁺ being most preferred. Other cations X⁺ may be selected from NH₄⁺, ½ Zn²⁺, ½ Mg²⁺, ½ Ca²⁺, ½ Mn²⁺, and mixtures thereof.

In various embodiments, (fatty alcohol) ether sulfates, in particular sodium lauryl ether sulfate, are used in the smallest possible amount. In preferred embodiments, fatty alcohol ether sulfates, in particular sodium lauryl ether sulfate, are used in an amount of less than 5 wt. %, particularly preferably less than 4 wt. %, more preferably less than 3 wt. %, extremely preferably less than 2 wt. %, in particular less than 1 wt. %, based on the total weight of the dishwashing agent. In various embodiments, the dishwashing agent is free of fatty alcohol ether sulfates, for example free of the below-defined fatty alcohol ether sulfates of formula I-1, for example free of lauryl ether sulfate.

Ether sulfates are, in particular, compounds of formula (I)

R¹—O-(AO)ₙ—SO₃—X⁺ (I).

In this formula (I), R¹ represents a linear or branched, substituted or unsubstituted alkyl group, for example a linear, unsubstituted alkyl group, typically a fatty alcohol group. Common groups R¹ are selected from decyl, undecyl, dodecyl, tridecyl, tetradecyl, pentadecyl, hexadecyl, heptadecyl, octadecyl, nonadecyl and eicosyl groups, and mixtures thereof, the representatives having an even number of C atoms being particularly customary. Typical groups R¹ are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols.

X represents a monovalent cation or the n-th part of an n-valent cation, examples of these being the alkali metal ions, and of those Na⁺ or K⁺, with Na⁺ being most preferred. Other cations X⁺ may be selected from NH₄⁺, ½ Zn²⁺, ½ Mg²⁺, ½ Ca²⁺, ½ Mn²⁺, and mixtures thereof.

AO represents an ethylene oxide (EO) or propylene oxide (PO) group, typically an ethylene oxide group. The index n represents an integer from 1 to 50, preferably from 1 to 20 or from 2 to 10. It is particularly common for n to represent the numbers 2, 3, 4, 5, 6, 7 or 8.

Fatty alcohol ether sulfates of formula I-1 are frequently used

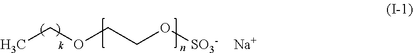

with k=11 to 19, n=2, 3, 4, 5, 6, 7 or 8, for example Na—C₁₂₋₁₄ fatty alcohol ether sulfates having 2 EO (k=11-13, n=2 in formula I-1).

If present, the at least one non-ionic surfactant is contained in 0.1 to 20 wt. %, preferably 0.5 to 10 wt. %, more preferably 1 to 8 wt. %, based on the total weight of the dishwashing agent.

All non-ionic surfactants known for dishwashing agents are suitable as non-ionic surfactants.

In one embodiment, the at least one non-ionic surfactant is selected from amine oxides, alkoxylated fatty acid alkyl esters, polyhydroxy fatty acid amides, alkyl glycosides and alkoxylated alcohols and mixtures thereof.

In a preferred embodiment, the at least one non-ionic surfactant selected from amine oxides, i.e., compounds which have the formula R¹R²R³NO, in which each R¹, R² and R³ independently of the others is an optionally substituted, for example hydroxy substituted, C₁-C₃₀ hydrocarbon chain, can be used. Amine oxides that are particularly preferably used are those in which R¹ is a C₁₂-C₁₈ alkyl and R² and R³ are, independently, each C₁-C₄ alkyl, in particular C₁₂-C₁₈ alkyl dimethyl amine oxides. Example representatives of suitable amine oxides are N-coco alkyl-N,N-dimethyl amine oxide and N-tallow alkyl-N,N-dihydroxyethyl amine oxide. C₁₂-C₁₈ alkyl dimethyl amine oxides or mixtures which also contain C₁₆ and C₁₈ alkyl dimethyl amine oxides are preferred over C₁₂-C₁₄ alkyl dimethyl amine oxides. In the same way, amine oxides in which R¹ also includes C₁₆ and C₁₈ groups are generally preferred over those in which R¹ only comprises C₁₂₋₁₄ groups. In various embodiments, the amine oxides used therefore contain at least 20 wt. %, preferably at least 30 wt. %, more preferably at least 40 wt. %, most preferably at least 50 wt. %, 60 wt. %, 70 wt. % or 80 wt. %, C₁₆₋₁₈ amine oxides, based on the total weight of the amine oxides. In such embodiments, the remainder of the amine oxides can consist of C₁₂₋₁₄ amine oxides. It has been shown that such long-chain amine oxides are superior to the shorter-chain amine oxides with regard to cleaning performance, in particular in the described surfactant combination.

The non-ionic surfactant is preferably selected from C₁₂₋₁₈ amine oxides, in particular from C₁₂₋₁₈ alkyl dimethyl amine oxides.

In another preferred embodiment, the non-ionic surfactant is selected from C₁₂-C₁₄ amine oxides, for example C₁₂-C₁₄ alkyl dimethyl amine oxides.

Another class of preferably used non-ionic surfactants, which are used either as the sole non-ionic surfactant or in combination with other non-ionic surfactants, are alkoxylated, preferably ethoxylated or ethoxylated and propoxylated, fatty acid alkyl esters, preferably having 1 to 4 carbon atoms in the alkyl chain.

Other suitable surfactants are the polyhydroxy fatty acid amides, which are known as PHFAs.

Alkyl glycosides of the general formula RO(G)x are also suitable, for example, in which R corresponds to a primary straight-chain or methyl-branched aliphatic group, in particular an aliphatic group that is methyl-branched in the 2 position and has 8 to 22, preferably 12 to 18, C atoms, and G is the symbol that represents a glycose unit having 5 or 6 C atoms, preferably glucose. The degree of oligomerization x, which indicates the distribution of monoglycosides and oligoglycosides, is any number between 1 and 10; x is preferably between 1.2 and 1.4.

In one embodiment, the non-ionic surfactants are selected from the group of alkoxylated alcohols. Non-ionic surfactants that are preferably used are alkoxylated, advantageously ethoxylated, in particular primary alcohols having preferably 8 to 18 C atoms and, on average, 1 to 12 mol ethylene oxide (EO) or propylene oxide (PO) per mol of alcohol and in which the alcohol group can be linear or preferably methyl-branched in the 2 position, or can contain linear and methyl-branched groups in admixture, as are usually present in oxo alcohol groups. However, alcohol ethoxylates having linear groups of alcohols of native origin having 12 to 18 C atoms, for example of coconut alcohol, palm alcohol, tallow fatty alcohol or oleyl alcohol, and an average of 2 to 8 mol EO per mol of alcohol, are particularly preferred. Preferred ethoxylated alcohols include, for example, C₁₂₋₁₄ alcohols having 3 EO or 4 EO, C₈₋₁₁ alcohol having 7 EO, C₁₃₋₁₅ alcohols having 3 EO, 5 EO, 7 EO or 8 EO, C₁₂₋₁₈ alcohols having 3 EO, 5 EO or 7 EO, and mixtures thereof, such as mixtures of C₁₂₋₁₄ alcohol having 3 EO and C₁₂₋₁₈ alcohol having 5 EO.

Preferred alcohol ethoxylates have a narrowed homologue distribution (narrow range ethoxylates, NRE). In addition to these non-ionic surfactants, fatty alcohols having more than 12 EO can also be used. Examples of these are tallow fatty alcohols having 14 EO, 25 EO, 30 EO, or 40 EO.

Ethoxylated non-ionic surfactants are particularly preferably used which were obtained from C₆₋₂₀ monohydroxy alkanols or C₆₋₂₀ alkyl phenols or C₁₆₋₂₀ fatty alcohols and more than 12 mol, preferably more than 15 mol, and in particular more than 20 mol, ethylene oxide per mol of alcohol. A particularly preferred non-ionic surfactant is obtained from a straight-chain fatty alcohol having 16 to 20 carbon atoms (C₁₆₋₂₀ alcohol), preferably from a C₁₈ alcohol and at least 12 mol, preferably at least 15 mol and in particular at least 20 mol of ethylene oxide. Of these, what are referred to as “narrow range ethoxylates” are particularly preferred.

In various embodiments, the total amount of surfactants, i.e., of the surfactant system, based on the weight of the agent, is 2.5 to 70 wt. %, preferably 5 to 50 wt. %, even more preferably 7 to 40 wt. %.

The dishwashing agent can also contain at least one additional ingredient selected from the group consisting of water, organic solvents, enzymes, additives for improving the flow and drying behavior, for adjusting the viscosity and/or for stabilization, UV stabilizers, perfume, pearlescing agents, dyes, corrosion inhibitors, preservatives, bitter substances, organic salts, disinfectants, structuring polymers, defoamers, encapsulated ingredients, pH adjusters and skin-feel-improving or nourishing additives.

In one embodiment, the dishwashing agents are liquid and contain water as the main solvent, i.e., they are aqueous dishwashing agents. The water content of the aqueous agent is usually 15 to 90 wt. %, preferably 20 to 60 wt. %. In various embodiments, the water content is more than 5 wt. %, preferably more than 15 wt. % and particularly preferably more than 25 wt. %, in each case based on the total amount of dishwashing agent.

In addition, organic solvents can be added to the dishwashing agent. Suitable organic solvents include monovalent or polyvalent alcohols, alkanolamines or glycol ethers, if they can be mixed with water in the stated concentration range. The solvents are preferably selected from ethanol, n-propanol, i-propanol, butanols, glycol, propanediol, butanediol, methylpropanediol, glycerol, diglycol, propylene diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butyl ether, di-n-octyl ether and mixtures of these solvents.

In various embodiments, the dishwashing agents described herein can also contain at least one enzyme, preferably a protease. The proteases used are preferably alkaline serine proteases. They act as unspecific endopeptidases, i.e., they hydrolyze any acid amide bonds that are inside peptides or proteins and thereby remove protein-containing stains on the item to be cleaned. Their optimum pH is usually in the distinctly alkaline range.

The proteases that are preferably used are preferably a serine protease, in particular a subtilase, particularly preferably a subtilisin. The subtilisin can be a wild-type enzyme or a subtilisin variant, the wild-type enzyme or the starting enzyme of the variant preferably being selected from one of the following:
the alkaline protease from Bacillus amyloliquefaciens (BPN′),
the alkaline protease from Bacillus licheniformis (subtilisin Carlsberg),
the alkaline protease PB92,
subtilisin 147 and/or 309 (Savinase)
the alkaline protease from Bacillus lentus, preferably from Bacillus lentus (DSM 5483),
the alkaline protease from Bacillus alcalophilus (DSM 11233),
the alkaline protease from Bacillus gibsonii (DSM 14391) or an alkaline protease that is at least 70% identical thereto,
the alkaline protease from Bacillus sp. (DSM 14390) or an alkaline protease that is at least 98.5% identical thereto, and
the alkaline protease from Bacillus sp. (DSM 14392) or an alkaline protease that is at least 98.1% identical thereto.

Examples of the proteases that can be used in the agents described herein are subtilisin 309 or functional fragments/variants thereof and variants of the alkaline protease from Bacillus lentus or variants thereof. Subtilisin 309 is sold under the trade name Savinase® by Novozymes A/S, Bagsvaerd, Denmark. From the subtilisin 309 from Bacillus lentus, optimized enzyme variants are available under the trade names Blaze® and Ovozyme® from Novozymes, which variants represent a preferred embodiment. The protease variants marketed under the name BLAP® are derived from the alkaline protease from Bacillus lentus DSM 5483, for example. Preferred here are in particular protease variants which have, compared to the BLAP wt (wild type) enzyme, at least one mutation at R99, in particular R99E or R99D, with R99E being particularly preferred, in the numbering according to BLAP wt, and optionally additionally at least one or two, preferably all three, of the amino acid substitutions S3T, V41 and V1991, with the BLAP variants as described in Seq. ID No. 4 or 5 of WO 2014/177430 being particularly preferred.

In the dishwashing agents described herein, the enzymes to be used may furthermore be packaged together with accompanying substances, for example from fermentation. In liquid agents, the enzymes are preferably used in the form of (an) enzyme liquid formulation(s).

The proteases are generally not provided in the form of pure protein, but rather in the form of stabilized, storable and transportable preparations. These pre-packaged preparations include, for example, the solid preparations obtained through granulation, extrusion, or lyophilization or, in particular in the case of liquid or gel agents, solutions of the enzymes, which are advantageously maximally concentrated, have a low water content, and/or are supplemented with stabilizers or other auxiliaries.

Alternatively, the enzymes can also be encapsulated, for both the solid and the liquid administration form, for example by spray-drying or extrusion of the enzyme solution together with a preferably natural polymer or in the form of capsules, for example those in which the enzymes are enclosed in a set gel, or in those of the core-shell type, in which an enzyme-containing core is coated with a water-, air-, and/or chemical-impermeable protective layer. Other active ingredients such as stabilizers, emulsifiers, pigments, bleaching agents, or dyes can additionally be applied in overlaid layers. Such capsules are applied using methods which are known per se, for example by shaking or rolling granulation or in fluidized bed processes. Such granules are advantageously low in dust, for example due to the application of polymeric film-formers, and stable in storage due to the coating.

Moreover, it is possible to formulate two or more enzymes together, such that a single granule exhibits a plurality of enzyme activities.

Dishwashing agents can alternatively or in addition to the at least one protease contain one or more other enzymes, in particular from the following group: amylases, hemicellulases, cellulases, lipases and oxidoreductases.

The dishwashing agent particularly preferably also contains at least one amylase.

The amylase(s) is/are preferably an α-amylase. The hemicellulase is preferably a β-glucanase, a pectinase, a pullulanase and/or a mannanase. The cellulase is preferably a cellulase mixture or a single-component cellulase, preferably or predominantly an endoglucanase and/or a cellobiohydrolase. The oxidoreductase is preferably an oxidase, in particular a choline-oxidase, or a perhydrolase. The enzymes mentioned can all be packaged as described above for the proteases.

In dishwashing agents, which in one embodiment are present predominantly in liquid, pasty or gel form, the at least one enzyme, preferably the at least one protease and/or at least one amylase, is contained in the dishwashing agent in an amount of from 0.01-1.6 wt. %, preferably 0.05-1.2 wt. % based on the total weight of said agent.

In various embodiments, the enzyme(s) can be pre-formulated, together with enzyme stabilizers, in an enzyme composition. The enzyme protein usually only forms a fraction of the total weight of the enzyme preparation. Enzyme preparations that are preferably used contain between 0.1 and 40 wt. %, preferably between 0.2 and 30 wt. %, particularly preferably between 0.4 and 20 wt. %, and in particular between 0.8 and 10 wt. % of the enzyme protein. In such compositions, an enzyme stabilizer can be contained in the enzyme composition in an amount of from 0.05-35 wt. %, preferably 0.05-10 wt. %, based on the total weight. This enzyme composition can then be used in dishwashing agents, specifically in amounts which lead to the final concentrations specified above in the dishwashing agent. Suitable enzyme stabilizers are known in the prior art. In various embodiments, the agent can accordingly additionally have one or more enzyme stabilizers.

The protein concentration can be determined using known methods, for example the BCA method (bicinchoninic acid; 2,2′-bichinolyl-4,4′-dicarboxylic acid) or the Biuret method.

The active protein concentration is determined by titrating the active centers using a suitable irreversible inhibitor (e.g., phenylmethylsulfonylfluoride (PMSF) for proteases) and determining the residual activity (cf. M. Bender et al., J. Am. Chem. Soc. 88, 24 (1966), p. 5890-5913).

To further improve the flow and/or drying behavior, the agent can contain one or more additives from the group of polymers and builders, usually in an amount of from 0.001 to 5 wt. %, preferably 0.01 to 4 wt. %, in particular 0.1 to 3 wt. %, particularly preferably 0.2 to 2 wt. %, extremely preferably 0.5 to 1.5 wt. %, for example 1 wt. %.

Polymeric thickening agents are the polycarboxylates which have a thickening action as polyelectrolytes, preferably homo- and copolymerizates of acrylic acid, in particular acrylic acid copolymers such as acrylic acid-methacrylic acid copolymers, and the polysaccharides, in particular heteropolysaccharides, and other conventional thickening polymers.

Suitable polysaccharides or heteropolysaccharides are the polysaccharide gums, for example gum arabic, agar, alginates, carrageenans and their salts, guar, guar gum, tragacanth, gellan, ramsan, dextran or xanthan and their derivatives, for example propoxylated guar, and mixtures thereof. Other polysaccharide thickeners, such as starches or cellulose derivatives, may be used alternatively to, but preferably in addition to, a polysaccharide gum, for example starches of various origins and starch derivatives, for example hydroxyethyl starch, starch phosphate esters or starch acetates, or carboxymethyl cellulose or its sodium salt, methyl, ethyl, hydroxyethyl, hydroxypropyl, hydroxypropyl methyl or hydroxyethyl methyl cellulose or cellulose acetate.

Acrylic acid polymers suitable as polymeric thickening agents are, for example, high-molecular-weight homopolymers of acrylic acid (INCI: carbomer) cross-linked with a polyalkenyl polyether, in particular an allyl ether of sucrose, pentaerythritol or propylene, and also referred to as carboxyvinyl polymers.

However, particularly suitable polymeric thickening agents are the following acrylic acid copolymers: (i) copolymers of two or more monomers from the group of acrylic acid, methacrylic acid and their simple ester, preferably formed with C₁₋₄ alkanols (INCI: acrylates copolymer), which copolymers include, for example, the copolymers of methacrylic acid, butyl acrylate and methyl methacrylate (CAS 25035-69-2) or of butyl acrylate and methyl methacrylate (CAS 25852-37-3); (ii) cross-linked high-molecular-weight acrylic acid copolymers, which include for instance the copolymers of C₁₀₋₃₀ alkyl acrylates, cross-linked with an allyl ether of sucrose or pentaerythritol, with one or more monomers from the group of acrylic acid, methacrylic acid and their simple esters, preferably formed by C₁₋₄ alkanols (INCI: acrylates/C₁₀₋₃₀ alkyl acrylate crosspolymer).

The content of polymeric thickening agent is usually not more than 8 wt. %, preferably between 0.1 and 7 wt. %, particularly preferably between 0.5 and 6 wt. %, in particular between 1 and 5 wt. % and most preferably between 1.5 and 4 wt. %, for example between 2 and 2.5 wt. %, based on the total weight of the dishwashing agent.

To stabilize the agent, in particular at a high surfactant content, one or more dicarboxylic acids and/or their salts can be added, in particular a composition of Na salts of adipic, succinic and glutaric acid, as is available for example under the trade name Sokalan® DSC. The use here is advantageously in amounts of from 0.1 to 8 wt. %, preferably 0.5 to 7 wt. %, in particular 1.3 to 6 wt. % and particularly preferably 2 to 4 wt. %, based on the total weight of the dishwashing agent.

However, if the use thereof can be dispensed with, the agent is preferably free of dicarboxylic acids (dicarboxylic acid salts).

In addition, one or more other auxiliaries and additives that are conventional in particular in hand dishwashing agents, in particular UV stabilizers, perfume, pearlescent agents (INCI opacifying agents; for example glycol distearate, e.g., Cutina® AGS from Cognis, or mixtures containing this, e.g., Euperlane® from Cognis), dyes, corrosion inhibitors, preservatives (for example technical 2-bromo-2-nitropropane-1,3-diol (CAS 52-51-7), also known as bronopol, which is commercially available from Boots for example as Myacide® BT or as Boots Bronopol BT) or Acticide MBR 1, organic salts, disinfectants, pH adjusters and skin-feel-improving or nourishing additives (e.g., dermatologically active substances such as vitamin A, vitamin B2, vitamin B12, vitamin C, vitamin E, D-panthenol, sericerin, collagen partial hydrolyzate, various vegetable protein partial hydrolyzates, protein hydrolyzate-fatty acid condensates, liposomes, cholesterol, vegetable and animal oils such as lecithin, soybean oil, etc., plant extracts such as aloe vera, azulene, witch hazel extracts, algae extracts, etc., allantoin, AHA complexes, glycerine, urea, quaternized hydroxyethyl cellulose), can be contained in amounts usually not more than 5 wt. %, based on the total weight of the dishwashing agent.

The pH of the agent can be adjusted by means of conventional pH regulators, for example acids such as mineral acids or citric acid and/or alkalis such as sodium or potassium hydroxide, with a range of from 4 to 9, preferably 5 to 8.5, in particular 5.5 to 8, being preferred, in particular for the desired hand compatibility.

In one embodiment, the dishwashing agent also contains potassium acetate.

To adjust and/or stabilize the pH, the agent can contain one or more buffer substances (INCI buffering agents), usually in amounts of from 0.001 to 5 wt. %, preferably 0.005 to 3 wt. %, in particular 0.01 to 2 wt. %, particularly preferably 0.05 to 1 wt. %, extremely preferably 0.1 to 0.5 wt. %, for example 0.2 wt. %. Buffer substances, which are also complexing agents or even chelating agents (chelators, INCI chelating agents), are preferred. Particularly preferred buffer substances are citric acid or the citrates, in particular the sodium and potassium citrates, for example trisodium citrate.2 H₂O and tripotassium citrate.H₂O.

The agent can be used for manually cleaning dishes.

The dishwashing agent is produced using customary and known methods and processes.

### EXAMPLES

### Example 1

TABLE 1

| Raw material | Wt. % |
|---|---|
| Na cumene sulfonate | 1.20 |
| C₁₂₋₁₄ alpha-olefin sulfonate | 24.79 |
| C₁₂₋₁₈ amine oxide | 6.20 |
| Acticide MBR 1 | 0.10 |
| Perfume | 0.38 |
| Liquitint Blue REID | 0.0306 |
| Potassium acetate | 0.20 |
| Citric acid | 0.73 |
| Enzyme | 0.20 |
| HET Ultra | 0.30 |
| NaCl | 1.10 |
| Remainder water to | |
| make up to 100 | |
| Total | 100.00 |

A dishwashing agent was produced by mixing the components listed in Table 1. The dishwashing agent of Example 1 demonstrated good solubility, prevents undesired skin formation and demonstrates a clear appearance. The pH was 7.7.

### Comparative Example 1

TABLE 2

| Raw material | Wt. % |
|---|---|
| Na cumene sulfonate | 0.56 |
| 1,2 propanediol | 2.40 |
| Ethanol | 5.00 |
| Sodium lauryl sulfate | 24.79 |
| C₁₂₋₁₈ amine oxide | 6.20 |
| Acticide MBR 1 | 0.10 |
| Perfume | 0.38 |
| Liquitint Blue REID | 0.0306 |
| Potassium acetate | 0.20 |
| Citric acid | 0.2950 |
| Enzyme | 0.00 |
| HET Ultra | 0.00 |
| NaCl | 0.20 |
| Remainder water to make up to 100 | |
| Total | 100.00 |

A dishwashing agent was produced by mixing the components listed in Table 2. The dishwashing agent of Comparative Example 1 did not contain any alpha-olefin sulfonate. The composition demonstrated skin formation and had poor solubility.

1. A dishwashing agent comprising a surfactant system, wherein the surfactant system comprises or consists of:
at least one alpha-olefin sulfonate; and
at least one additional surfactant different from the at least one alpha-olefin sulfonate, wherein the at least one additional surfactant is an anionic surfactant, a non-ionic surfactant, or combinations thereof.

2. The dishwashing agent according to claim 1, wherein the at least one alpha-olefin sulfonate
(i) is selected from C₁₀₋₂₀ alpha-olefin sulfonates; and/or
(ii) is present in the dishwashing agent in an amount ranging from 2.5 to 50 wt. % based on the total weight of the dishwashing agent.

3. The dishwashing agent according to claim 1, wherein the anionic surfactant
(i) is present in the dishwashing agent in an amount ranging from about 0.1 to 45 wt. % based on the total weight of the dishwashing agent; and/or
(ii) is selected from alkylbenzene sulfonates, alkyl sulfates, and mixtures thereof.

4. The dishwashing agent according to claim 1, wherein the non-ionic surfactant
(i) is present in the dishwashing agent in an amount ranging from about 0.1 to 20 wt. % based on the total weight of the dishwashing agent; and/or
(ii) is selected from amine oxides, alkoxylated fatty acid alkyl esters, polyhydroxy fatty acid amides, alkyl glycosides, alkoxylated alcohols, and combinations thereof.

5. The dishwashing agent according to claim 1,
wherein the non-ionic surfactant comprises at least one amine oxide, wherein the at least one alpha-olefin sulfonate is present in the dishwashing agent in an amount ranging from about 2.5 to 50 wt. % based on the total weight of the dishwashing agent; and
wherein the at least one amine oxide is present in the dishwashing agent in an amount ranging from about 0.1 to 20 wt. % based on the total weight of the dishwashing agent.

6. The dishwashing agent according to claim 1, wherein the dishwashing agent comprises ether sulfates in an amount less than 5 wt. %, based on the total weight of the dishwashing agent.

7. The dishwashing agent according to claim 1, wherein the surfactant system is present in the dishwashing agent in an amount ranging from 2.5 to 70 wt. % based on the total weight of the dishwashing agent.

8. The dishwashing agent according to claim 1, wherein the dishwashing agent further comprises at least one additional ingredient selected from the group consisting of water, organic solvents, enzymes, additives for improving the flow and drying behavior, additives for adjusting the viscosity and/or for stabilization, UV stabilizers, perfume, pearlescing agents, dyes, corrosion inhibitors, preservatives, bitter substances, organic salts, disinfectants, structuring polymers, defoamers, encapsulated ingredients, pH adjusters, skin-feel-improving or nourishing additives, and combinations thereof.

9. (canceled)

10. The dishwashing agent of claim 1, wherein the at least one alpha-olefin sulfonate is a linear C₁₀₋₂₀ alpha-olefin sulfonate.

11. The dishwashing agent of claim 1, wherein the at least one alpha-olefin sulfonate is present in the dishwashing agent in an amount ranging from 5 to 25 wt. % based on the total weight of the dishwashing agent.

12. The dishwashing agent of claim 1, wherein the anionic surfactant is present in the dishwashing agent in an amount ranging from 5 to 25 wt. % based on the total weight of the dishwashing agent.

13. The dishwashing agent of claim 1, wherein the anionic surfactant is an alkylbenzene sulfonate.

14. The dishwashing agent of claim 1, wherein the non-ionic surfactant is present in the dishwashing agent in an amount ranging from 1 to 8 wt. % based on the total weight of the dishwashing agent.

15. The dishwashing agent of claim 1, wherein the non-ionic surfactant is a C₁₂₋₁₈ alkyl dimethyl amine oxide.

16. The dishwashing agent of claim 6, wherein the ether sulfates are present in an amount less than 1 wt. % based on the total weight of the dishwashing agent.

17. The dishwashing agent of claim 1, wherein the surfactant system is present in the dishwashing agent in an amount ranging from 7 to 40 wt. % based on the total weight of the dishwashing agent.
